(19) United States
(12) Patent Application Publication
(10) Pub. No.: US 2012/0107592 A1
(43) Pub. Date: May 3, 2012

(54) ACTIVE POLYMERIC FILMS

(76) Inventors: Krasimir A. Vasilev, South Australia (AU); Hans J. Griesser, South Australia (AU)

(21) Appl. No.: 13/139,943

(22) PCT Filed: Dec. 16, 2009
(86) PCT No.: PCT/AU2009/001635

§ 371 Date: Jun. 15, 2011

(30) Foreign Application Priority Data
Dec. 17, 2008 (AU) 2008906500

(51) Int. Cl. C08L 79/02; B32B 3/00; B32B 5/16; C09D 179/02; C08K 3/02; C08K 3/08; C08L 39/00; C08F 2/46; C09D 139/00

(52) U.S. Cl. 428/220; 427/488; 428/323; 521/50; 521/142; 523/122; 524/80; 524/440; 524/555; 524/612

(57) ABSTRACT

Active polymeric films are described which comprise a permeable polymer matrix provided with one or more functional groups and, embedded within the polymer matrix, one or more nanoparticles of an inorganic substance(s) such as copper or silver to provide antibacterial properties.

### FIELD OF THE INVENTION

The present invention generally relates to active polymeric films. More particularly, the invention relates to a film comprising a polymer matrix with embedded nanoparticles of an inorganic substance(s).

### INCORPORATION BY REFERENCE

This patent application claims priority from:
Australian Provisional Patent Application No 2008906500 titled “Active polymeric films” filed 17 Dec. 2008.

The entire content of this application is hereby incorporated by reference.

This patent application also makes reference to:
Griesser, H J (1989), Small scale reactor for plasma processing of moving substrate web, Vacuum 39(5):485-488.

The entire content of this document is hereby incorporated by reference.

### BACKGROUND OF THE INVENTION

Microbial infection or contamination remains a significant cause of illness and/or spoilage in medical, food processing, pharmaceutical processing and environmental settings. Further, while all surgical interventions carry some risk of wound infection, microbial attachment, colonisation and/or biofilm formation on the surface of medical implants during or after implant surgeries greatly increases the risk of infection. Microbial biofilms are, further, known to form on the surface of processing equipment, for instance in the food, pharmaceutical and chemical industries, and on other surfaces such as those within irrigation equipment, storm or wastewater pipelines, cooling towers or on marine vessels. Biofilms are frequently the cause of serious damage to such equipment and, in addition, microbial biofilm build-up can cause blockages in pipelines and processing equipment.

Microbial control can be managed with the use of bacteriostatic or bacteriocidal agents. Bacteriostatic agents prevent the further growth of microorganisms which, in turn, can prevent biofilm formation or, when administered in a medical setting, can prevent infections from developing into full blown illnesses. Bacteriocidal agents, on the other hand, act by killing microorganisms. Few bacteriocidal agents have a broad spectrum effect on microorganisms, and in some instances, a combination of agents may be required to manage microbial growth. However, most broad spectrum bacteriocidal agents are unsuitable for use for medical applications as they also tend to have deleterious effects on the tissues of higher organisms. Further, while antibiotics, which are usually active on bacteria alone, offer the possibility of treating or preventing microbial infection in humans and other animals without causing such deleterious effects, there is, unfortunately, few antibiotic agents which show a broad spectrum of activity (ie their bacteriocidal activity is often specific to certain bacterial species or genera). Moreover, the widespread and frequent use of antibiotics over many years has led to the evolution of antibiotic resistant or multi-resistant strains of bacteria (eg methicillin-resistant Staphylococcus aureus; MRSA). Thus, antibiotics may be ineffective on certain bacterial infections.

Thus, considerable and ongoing research efforts have been directed to the development of new bacteriostatic or bacteriocidal agents for use in medical applications. This need has also been exacerbated by the global need to reduce hospital acquired infection rates, ageing populations in the western world, growing concerns to minimise healthcare costs, and increasingly informed patients that demand improved medical treatments. In this regard, there has been a growing acceptance of antimicrobial coatings and surfaces for medical implants and prostheses as a promising approach to combating bacterial infections during and after surgery. To this end, the development of alternative antimicrobial technologies, such as nano-based coating technologies, is gaining momentum. Medical devices that have been contemplated as potential candidates for antimicrobial coating and surface technologies include wound dressings, catheters and medical implants such as stents and pacemakers.

The antimicrobial properties of silver have been recognised for many years. Due to the cost of silver and the relative difficulty of administration relative to modern antibiotics, silver has garnered little interest as an antimicrobial agent until recently. That is, in recent years, there has been a resurgence of interest shown in the potential uses of silver as an antimicrobial agent. For instance, silver compounds and colloids have been integrated into bandages for burn wounds, in acute and chronic wounds, and in treatments for leg ulcers. Indeed, the product known as Silvadene® cream, containing 1% silver sulphadiazine, is now one of the most widely used antimicrobial products for the treatment of infections associated with burns. In addition, several recent studies have demonstrated the capacity of silver ions associated with macro or nanoparticulate surfaces to reduce the incidence of microbial infections and bacterial attachment and/or colonisation in medical applications. These include, for example, burns curing (Paddock et al, 2007; Caruso et al, 2004), catheter implantation (Rupp et al, 2004; Yobin and Bambauer, 2003), prosthesis implantation (Hardman et al, 2004; Gosheger et al, 2004), arthroplasty (Alt et al, 2004), in dental prostheses (O'Donnell et al, 2007; Ohashi et al, 2004) and other medical applications. Potential non-medical applications of antimicrobial coatings and surfaces comprising silver include, for example, water treatment apparatus and systems (Chou et al, 2005; Martinez et al, 2004) and textiles (Paddock et al, 2007; Dubas et al, 2006; Lee et al, 2003). Some literature reviews explore the possibility of creating antimicrobial coatings comprising silver nanoparticles utilising means such as layer-by-layer deposition (Dubas et al, 2006; Li et al 2006), sol-gel processes (Marini et al, 2007; Mahltig et al, 2004), electrochemistry (Voccia et al, 2006), ion beam deposition (Song et al, 20005), and chemical vapour deposition (Martin et al, 2007).

Described herein are plasma polymerisation methods for forming polymer films loaded with nanoparticles of inorganic substance(s).

The films produced in this manner may be suitable for coating any suitable substrate, including those with hard or soft surfaces. They may also be used to coat surfaces so as functionalise the surfaces of a suitable substrate, for instance, to confer antimicrobial activity and/or to prevent undesirable bacterial attachment, colonisation and/or biofilm formation or, otherwise, to coat optical or electronic devices with a desired inorganic substance(s). The methods described herein, may further provide sustained release coatings for a bioactive inorganic substance(s) (eg an antimicrobial agent) or simply provide a means to affix an inorganic substance(s) to a surface.

### SUMMARY OF THE INVENTION

In a first aspect, the present invention provides a film comprising a permeable polymer matrix provided with one or more functional groups and, embedded within said polymer matrix, one or more nanoparticles of an inorganic substance(s).

Preferably, the inorganic substance is silver.

In a second aspect, the present invention provides a method for applying a film onto a surface of a suitable substrate, said method comprising the steps of:
(i) depositing and polymerising a monomer(s) comprising one or more functional groups by plasma polymerisation to form a permeable polymer matrix on said surface;
(ii) complexing an inorganic substance(s) to said functional groups, and
(iii) reducing said inorganic substance(s) to form one or more nanoparticles of said inorganic substance(s);
wherein said one or more nanoparticles of said inorganic substance(s) is embedded within said polymer matrix.

The method may be adapted for the production of a multi-layered film, wherein the film produced by steps (i) to (ii) constitutes a first film layer comprising a first polymer matrix provided with one or more functional groups and, embedded within said first polymer matrix, one or more nanoparticles of an inorganic substance(s), and the method further comprises the step of;
(iv) applying a second film layer to a surface of the first film layer.

### BRIEF DESCRIPTION OF THE FIGURES

FIG. 1 provides a schematic representation of the experimental strategy for the fabrication of HA-silver plasma polymer (pp) films: (a) illustrates plasma deposition of n-heptylamine (HA); (b) illustrates the methods of loading HA plasma films with silver ions by immersion in an AgNO₃ solution; and (c) illustrates the reduction of silver ions to form silver nanoparticles by immersion in NaBH₄;

FIG. 2 illustrates the formation of silver nanoparticles within a HA film formed on a glass solid surface: (a)(i) shows the opacity of the glass solid surface following deposition of a 100 nm HA plasma film; (a)(ii) shows the opacity of the glass solid surface following loading of the HA plasma film with silver ions; and (a)(iii) shows the opacity of the glass solid surface following the reduction of silver ions with NaBH₄; (b) shows the UV-visible spectra of samples after loading with silver ions (lower line) and after reduction in NaBH₄ (upper line), with wavelength (nm) shown on the X-axis and absorbance shown on the Y-axis;

FIG. 3 illustrates various adjustments to silver nanoparticle loading concentrations: (a) shows the effect of time of immersion in AgNO₃ with a reduction time of 30 min in HA-silver films of 100 nm thickness; (b) shows the effect of time of reduction with an AgNO₃ immersion time of 1 hr in HA-silver films of 100 nm thickness; and (c) shows the effect of thickness of the HA-silver plasma film with an AgNO₃ immersion time of 1 hour and reduction time of 30 min. The Y-axis shows the intensity of absorption maxima with time (min or sec) shown on the X-axis;

FIG. 4 illustrates the adjustment of the rate of release of silver ions from HA-silver plasma films following the deposition of an additional layer of HA plasma film: (a) illustrates the rate of release of silver ions from the films over 21 days immersion in phosphate buffered saline (PBS) with squares indicating the release rate of HA-silver plasma films, circles indicating the additional deposition of a 6 nm HA plasma film on the surface of the HA-silver plasma film, and triangles indicating the additional deposition of a 12 nm HA plasma film on the surface of the HA-silver plasma film; and (b) illustrates the methods involved in preparing bi-layered plasma films. The solid substrate is illustrated in the lower portion, an HA-silver layer shown in the middle portion and an additional HA layer is shown in the upper portion;

FIG. 5 shows bacterial growth and colonisation of HA-silver plasma films in contrast with HA plasma films: (a) illustrates bacterial growth on a HA plasma film; (b) illustrates bacterial growth and colonisation on HA-silver plasma film; and (c) illustrates bacterial growth and colonisation on bi-layered plasma film comprising a 6 nm second layer of HA plasma polymer,

FIG. 6 provides a bar graph of the estimated bacterial inhibition area produced from samples of HA-silver plasma films placed on Petri dishes filled with LB medium and 100 μl of Escherichia coli K12 (MG1655) strain;

FIG. 7 shows the UV-visible spectra of an allylamine (AA) plasma polymer film sample after loading of with silver ions and reduction in NaBH₄, with wavelength (nm) shown on the X-axis and absorbance shown on the Y-axis;

FIG. 8 illustrates the adjustment of the rate of release of silver ions from AA-silver plasma films following the deposition of an additional layer of AA plasma film: in particular, the figure shows the rate of release of silver ions from the films over 20 days immersion in PBS with squares indicating the release rate of AA-silver plasma film, circles indicating the effect of an additional deposition of a 6 nm AA plasma film on the surface of the AA-silver plasma film, upwards pointing triangles indicating the effect of an additional deposition of a 12 nm AA plasma film on the surface of the AA-silver plasma film, and downwards pointing triangles indicating the effect of an additional deposition of a 12 nm AA plasma film on the surface of the AA-silver plasma film; and

FIG. 9 provides the UV-visible spectra of the coating of the glass substrate before and after PEG grafting (coatings are HA-silver plasma film without PEG (ie HA+silver nanoparticles (SNP)) and with PEG (ie HA+SNP+PEG).

### DETAILED DESCRIPTION OF THE INVENTION

The present applicant has identified and developed films, and methods for producing same, comprising polymers with nanoparticles of an inorganic substance(s) embedded therein. These films may find any number of applications, for instance, in the fabrication of antimicrobial coatings or surfaces. The methods of producing the films may provide a fast, simple and convenient process for applying active polymeric films to surfaces.

Thus, in a first aspect, the present invention provides a film comprising a permeable polymer matrix provided with one or more functional groups and, embedded within said polymer matrix, one or more nanoparticles of an inorganic substance(s).

The term “film” as used herein includes any physical surface layer which may provide, for example, certain properties to an underlying surface (eg a solid surface) to which it may have been applied. As such, the film may be of irregular or uniform thickness or composition and may partially or completely enclose or cover an underlying surface.

The film according to the first aspect comprises a polymer matrix, within which the nanoparticle(s) are embedded, and which is permeable to the said inorganic substance (eg the inorganic substance may diffuse into and out of the polymer matrix).

The polymer matrix may be porous, comprising a multiplicity of pores, generally nanopores (eg pores of about 2 nm to about 4 μm in diameter, more preferably about 5 nm to 1 μm), which may be discrete, interconnected or a combination of both. The inorganic nanoparticles may be located within the pores of the polymer matrix.

Preferably, the film comprises a plasma polymer matrix. Such a polymer matrix may, therefore, be formed from a plasma polymerisation process wherein at least one monomer is polymerised to form a polymer matrix. More preferably, the film comprises a porous plasma polymer matrix.

It is well recognised by persons skilled in the art that coatings comprising a plasma polymer matrix can often be “rigid” which can lead to coating failure due to shrinkage and collapse. It is suspected that the rigidity of such coatings results from the cross-linking of constituent monomers during the plasma polymerisation process. The film of the first aspect is, therefore, preferably a thin film comprising a thin, flexible polymer matrix. Apart from the potential to be less prone to failure, which is particularly important in medical applications, such a thin film may also be well suited for “soft” applications such as the surface coating of contact lenses. The film of the first aspect may also comprise a plasma polymer matrix with a low density of cross-links so as to provide mechanical flexibility.

A thin film may be formed from any thin film deposition method well known to persons skilled in the art including, but not limited to, chemical deposition methods such as plating, chemical solution deposition (CSD) and chemical vapour deposition (CVD), physical deposition methods such as physical vapour deposition (PVD), thermal evaporation, electron beam evaporation, sputtering, pulsed laser deposition and cathodic arc deposition (Arc-PVD), and other methods such as reactive sputtering, molecular beam epitaxy (MBE) and topotaxy. A thin film is preferably less than about 4 μm, more preferably between about 5 nm and about 4 μm, still more preferably between about 5 nm and 500 nm, yet still more preferably between about 5 nm and 150 nm, and most preferably from about 5 nm to about 25 nm in thickness.

The term “functional group” as used herein includes an atom or a specific group of atoms of the polymer matrix (or a monomer constituting the polymer matrix) with which any inorganic substance(s) may be chemically associated by, for example, covalent, ionic or ligand bonding (eg to form a complex).

The term “nanoparticles” as used herein is to be understood as referring to “nano”-sized particles which may comprise variously sized particles, and may typically show a mean or average diameter or major cross-sectional dimension in the range of 1 to 250 nm, more preferably in the range of 5 to 50 nm, and most preferably in the range of 10 to 25 nm.

The term “inorganic substance” as used herein includes a non-carbon element in a substantially pure form (eg copper, silver or selenium) and any inorganic compound that is predominantly formed from elements other than carbon. While certain compounds that contain carbon are considered to be inorganic compounds, such as carbonates, simple oxides of carbon and cyanides, as well as allotropes of carbon, compounds comprising a carbon backbone and organometallic compounds are not, for the purposes of the present specification, to be considered as inorganic compounds.

The film of the first aspect may be used as a coating on the surface of any suitable, preferably solid, substrate. Preferably, no pre-modification of the surface is performed for the application of the film.

Suitable “hard” substrates include metals, ceramics, synthetic polymers, biopolymers and materials of the kind often encountered in medical applications including stainless steel, titanium, polypropylene titanium, hydroxyapatite, polyethylene, polyurethanes, organosiloxane polymers and perfluorinated polymers. Suitable “soft” substrates include acrylic hydrogel polymers and siloxane hydrogel polymers, fibrous bandage and dressing materials, as well as synthetic dressings such as hydrogel or foam dressings.

In addition, it is considered that the film of the first aspect may be suitable for coating materials used as manufacturing and packaging materials such as plastics (eg polypropylene, polystyrene, polyethylene terephthalate, polyester, polyamides, polyvinyl chloride, polyurethanes, polycarbonates, polyvinylidene chlorides and polyethylene etc), metals and metal alloys
(eg stainless steel, steel, iron and tin etc). Further, materials used in optical or electronic devices such as silicon, silica, aluminium, copper and the like may be coated with a film according to the first aspect.

The film of the first aspect preferably comprises a polymer matrix formed from a monomer(s) comprising one or more functional groups that may form a complex with an oxidised form of said inorganic substance(s). As such, preferred monomers comprise at least one functional group selected from the group consisting of hydroxyl, carbonyl, aldehyde, ketone, carboxyl, hydroperoxy, carboxamide, amine, imine, imide, azide, cyanate, and nitrate groups. However, most preferred, are monomers which comprise at least one amine group. For example, monomers selected from the group consisting of volatile amines including, for example, allyamine, bis(dimethylamino)methylvinylsilane, dimethyl aminosilane, pyridine, and heptylamine. In some embodiments of the present invention, the monomer(s) may be selected from those that may be polymerised to form biocompatible polymers. Further, in some embodiments, the monomer(s) may be selected from those that may be functionalised following polymerisation or which may otherwise be co-polymerised to functionalise the resultant polymer matrix.

Most preferably, the film of the first aspect comprises a monomer(s) selected from the group consisting of allyamine, heptylamine and other volatile alkylamine.

In one particularly preferred embodiment, the film comprises a polymer matrix formed from n-heptylamine (HA), allylamine (AA) or a combination thereof. As illustrated in the following examples, n-heptylamine and allylamine have been found to be especially useful in the fabrication of thin films rich in amine functional groups. Further, n-heptylamine is known to be much less volatile and toxic than other amine-rich monomers well known to persons skilled in the art, and thus, a film comprising a polymer matrix formed thereof may be especially suitable for medical applications as well as food and/or pharmaceutical processing applications. In addition, the physicochemical properties of n-heptylamine and allylamine, as shown in the following examples, may be suitable for modifying the concentration and release of the nanoparticles of an inorganic substance(s) embedded therein, if desired.

The film of the first aspect may be used to functionalise a suitable, preferably solid, substrate with said inorganic substance(s). Such a functionalised substrate may find many applications, for instance in medical applications such as the coating of medical implants, coating materials generally for the prevention of microbial attachment, colonisation and/or biofilm formation, in optics for generating reflective or anti-reflective coatings, and in coating surfaces of electronic devices to form, for example, layer insulators, conductors for integrated circuits, microprocessors and semiconductors. The film may, therefore, be used to functionalise a suitable substrate with inorganic compounds such as arsenic trioxide (eg for coating arsenide semiconductors or in the treatment of acute myeloid leukemia), boric acid (eg for antiseptic or insecticidal surfaces), magnesium sulfate or magnesium oxide (eg for a range of medical applications), silicon dioxide (eg for use in microelectronics as an electric insulator), zinc oxide (eg for use in chemical and biosensors, in semiconductors or as a medicinal nutritional supplement), selenate (eg for use as a nutritional supplement) and the like. Alternatively, the film may be used to functionalise a suitable substrate with a non-carbon element such as a metal (eg copper, silver, gold, magnesium and zinc, or a metal alloy) for forming antimicrobial surfaces or coatings (eg for medical devices including implantable and non-implantable devices such as replacement joints, urinary catheters, percutaneous access catheters, stents, and other prostheses as well as non-implantable devices such as bandages, wound dressings, contact lenses and masks and apparatus for breathing medical air and oxygen) or in coating semiconductors and microprocessors, selenium for, for example, coating solar cells or for use as a nutritional supplement, and non-metals (eg fluoride for coating dental prostheses).

Where the film comprises nanoparticles of an elemental metal, preferably the metal is selected from copper or silver (metals that are well-recognised antimicrobial agents and can be well tolerated following administration to higher organisms), or a mixture thereof. Such a film is preferably formed by complexing an oxidised (ie ionic) form of the particular metal with functional groups capable of forming a complex with the metal ions in the polymer matrix. Thereafter, said complex is reduced to form nanoparticles embedded within the polymer matrix. Most preferably, such a film is formed from plasma polymerisation of n-heptylamine and/or allylamine followed by formation of an amine-metal ion complex.

An antimicrobial film according to the present invention (eg comprising nanoparticles of copper, silver, selenium or a mixture thereof), may be suitable for a range of medical applications such as those mentioned above. Such an antimicrobial film comprises a polymer matrix that is permeable to the antimicrobial agent constituting the nanoparticles. That is, the antimicrobial agent, over time, may dissolve (eg into fluid that has permeated into the film) or dissociate from the nanoparticles, and thereafter permeate out of the film to the surface and/or surrounds where the agent may exert its antimicrobial activity. Thus, where the antimicrobial film comprises nanoparticles of copper or silver for example, the polymer matrix is preferably permeable to metal ions (eg Cu⁺ and Ag⁺).

An antimicrobial film according to the present invention (eg comprising nanoparticles of copper, silver, selenium or a mixture thereof), may also be suitable for non-medical applications where inhibition of microbial attachment colonisation and/or biofilm formation is desired. For example, industrial surfaces that frequently come into contact with aqueous streams are particularly susceptible to biofilm formation, thus an antimicrobial film, as described herein, may be suitable for application to such surfaces. Particular examples of suitable non-medical applications include the coating of water treatment equipment, the coating of cooling tower components, the coating of processing equipment particularly in food and pharmaceutical production processes, and the coating of packaging for foods and pharmaceuticals. Further, an antimicrobial film according to the invention may be used to provide a corrosion resistant barrier to a suitable, preferably solid, substrate (ie the film may provide an anti-corrosive coating).

Moreover, where the film comprises nanoparticles of an elemental metal, particularly copper, silver and gold (which are well known for their electrical conductivity), the film may be suitable for coating semiconductors or microprocessors.

In some embodiments, the film of the first aspect may be a multi-layered film (ie comprising two or more film layers). Accordingly, the film may comprise first and second polymer film layers, said first film layer comprising a polymer matrix (preferably porous) provided with one or more functional groups and, embedded within said polymer matrix, one or more nanoparticles of an inorganic substance(s), and wherein said second film layer may, for example, provide the film with additional functional characteristics and/or modify the properties of the first film layer (eg to modify the rate of permeation of an antimicrobial agent from the first film layer such as to provide a multi-layered film capable of releasing an antimicrobial agent or another inorganic substance(s) in a sustained manner), or alternatively, such that the second film layer is essentially impermeable to the inorganic substance(s) embedded in the first film layer so as to effectively “trap” the inorganic substance(s). The second film layer may also comprise a useful ligand such as a protein or peptide (including growth factors beneficial for host cell attachment and/or growth) or other chemical compounds such as a polyether (eg polyethylene glycol) for conferring resistance to biological adhesion.

Thus, in some embodiments, the film of the first aspect comprises first and second polymer film layers, wherein said first film layer comprises a first polymer matrix (preferably porous) provided with one or more functional groups and, embedded within said first polymer matrix, one or more nanoparticles of a first inorganic substance(s), and wherein said second film layer comprises a second polymer matrix (preferably porous) provided with one or more functional groups (eg metal ion complexing functional groups) and, embedded within said second polymer matrix, one or more nanoparticles of a second inorganic substance(s) (wherein the first and second inorganic substance(s) may be the same or different), while in other embodiments, the film of the first aspect comprises first and second polymer film layers, wherein said first film layer comprises a first polymer matrix (preferably porous) provided with one or more functional groups and, embedded within said first polymer matrix, one or more nanoparticles of an inorganic substance(s), and wherein said second film layer comprises a second polymer matrix which controls the permeation of said inorganic substance(s) (eg the second polymer matrix may be poorly permeable to said inorganic substance(s) or is essentially impermeable to said inorganic substance(s)).

Further, at least a third film layer may be added which may comprise a useful ligand such as a protein or peptide, or other chemical compounds such as a polyether to, for example, exrt specific bio-interfacial effects such as cell attachment or resistance to cell attachment.

Any second or third (etc) film layer is preferably less than about 100 nm, and most preferably from about 1 nm to about 50 nm, more preferably from about 5 to about 25 nm in thickness.

Moreover, in some embodiments, the film of the first aspect may be “triggered” to release (ie through permeation) an inorganic substance from the nanoparticles embedded within the polymer matrix by subjecting the film to an oxidising agent (eg by subjecting the film to biological fluids, or other aqueous substances such as cooling towers waters, wastewaters or environmental waters).

In a second aspect, the present invention provides a method for applying a film onto a surface of a suitable substrate, said method comprising the steps of:
(i) depositing and polymerising a monomer(s) comprising one or more functional groups (eg metal ion complexing functional groups) by plasma polymerisation to form a permeable polymer matrix on said surface;
(ii) complexing an inorganic substance(s) to said functional groups, and
(iii) reducing said inorganic substance(s) to form one or more nanoparticles of said inorganic substance(s);
wherein said one or more nanoparticles of said inorganic substance(s) is embedded within said polymer matrix.

Preferably, the polymer matrix is a porous polymer matrix.

Plasma polymerisation may be suitable for depositing and polymerising a monomer(s) (ie to produce a polymer matrix) on a surface of any suitable substrate such as the hard and soft substrates mentioned above. Further, the plasma polymerisation process allows for the selection of an appropriate monomer(s) that may suitably modify surface properties (eg by providing hydrophilicity or hydrophobicity). Moreover, the plasma polymerisation process may be operated so as to achieve a polymeric matrix with a desired density of cross-links which, in turn, may enable the adjustment (if desired) of any out-diffusion rate of the inorganic substance(s) from the embedded nanoparticle(s).

The step of polymerising the monomers is preferably performed by a plasma polymerisation process such as radio frequency glow discharge plasma polymerisation, such that a porous plasma polymer matrix is formed. Preferred monomers are as described in relation to the first aspect of the invention. Most preferably, the monomer is n-heptylamine, allylamine or a combination thereof, and polymerisation results in the formation of a polymer matrix rich in amine functional groups.

The step of complexing the inorganic substance(s) to the functional groups may involve any of the methods well known to persons skilled in the art. However, preferably, the step of complexing the inorganic substance(s) to the functional groups involves immersing the polymer matrix formed in step (i) in a solution comprising said inorganic substance(s). For instance, in order to complex silver ions to a polymer matrix rich in amine functional groups, the polymer matrix may be immersed in a solution of AgNO₃ (eg 0.02 M for 1 hr).

The step of reducing the inorganic substance(s) may be performed using any of the methods well known to persons skilled in the art. However, preferably, the step of reducing the inorganic substance(s) involves immersing the polymer matrix comprising the inorganic substance(s) complexed to the functional groups in a reducing agent. For instance, in order to reduce a silver ion and amine functional group complex to form silver nanoparticles, the polymer matrix may be immersed in a solution of NaBH₄ (eg 0.01M for 30 min).

Any one or more of the steps (i), (ii) and (iii) of the method of the second aspect (ie the steps of depositing and polymerising, complexing and/or reducing), may be performed so as to control the amount of the nanoparticles of the inorganic substance(s) embedded within the polymer matrix. For instance, step (i) may be performed to control the amount of nanoparticles by varying the thickness of the polymer (eg by controlling the duration of radio frequency glow discharge (rfgd) plasma deposition and polymerisation), step (ii) may be performed to control the amount of nanoparticles by varying the duration of immersion of the polymer matrix to the inorganic substance(s), and step (iii) may be performed to control the amount of nanoparticles by varying the duration of immersion of the polymer matrix to a reducing agent.

Preferably, the method of the second aspect does not involve any pre-modification of substrate surface.

The method of the second aspect results in the application of a film onto a surface of a suitable substrate wherein, embedded within the polymer matrix of the film, is one or more nanoparticles of an inorganic substance(s). The nanoparticles may confer desirable properties to the film, such as reflectivity, or may provide for the sustained release of inorganic substance(s) such as antimicrobial silver ions. The method may also be used in a manner which results in the modification of surface properties of the films or for otherwise attaching a further moiety (eg another chemically reactive functional group or further film layer or coating to the surface).

The method of the second aspect may be adapted for the production of a multi-layered film, wherein the film produced by steps (i) to (iii) constitutes a first film layer comprising a first polymer matrix (preferably porous) provided with one or more functional groups and, embedded within said first polymer matrix, one or more nanoparticles of an inorganic substance(s), and the method further comprises the step of;
(iv) applying a second film layer to a surface of the first film layer.

The second film layer may provide the film with additional functional characteristics and/or modify the properties of the first film layer as described above in relation to the first aspect.

Moreover, the method may further comprise the step of;
(v) applying a third film layer to a surface of the second film layer.

Appropriate plasma polymerisation conditions for the production of multi-layered films (eg so as to control, for instance, the thickness of the second film layer, or the rate of any out-diffusion (if desired) of the inorganic substance(s) from the nanoparticles of the first polymer matrix) may be selected to suit the requirements of the particular multi-layered film and the intended application.

The invention is hereinafter further described by way of the following non-limiting examples and accompanying figures.

### EXAMPLES

N-heptylamine (HA) and allylamine (AA) were selected as the materials of choice for plasma deposition to provide plasma films functionalised with amine groups. While n-heptylamine and allylamine were utilised throughout the examples, it is to be understood that the methods described herein could equally utilise other functionalised monomers such as bis(dimethylamino)methylvinylsilane, dimethyl aminosilane, pyridine, ethylene oxides, allylalcohols, ethylene glycols, monomethyl ethers, acrylic acids, N-vinylpyrrolidone, acetylenes or ethylenes or functionalised monomers that provide other groups capable of complexing in-diffusing inorganic material, such as hydroxyls, carbonyls, aldehydes, ketones, carbonates, carboxylates, carboxyls, ethers, esters, hydroperoxys, peroxys, carboxamides, amines, imines, imides, azides, azos, cyanates, isocyanides, isocyanates, nitrates, nitriles, nitrosooxys, nitros, nitrosos, pyridyls, phosphinos, phosphos, phosphonos, sulfonyls, sulfos, sulfinyls, sulfhydryls, thiocyanates or disulfides. In particular, the n-heptylamine or allylamine (Vasilev et al, 2009) may be substituted by diaminocyclohexane (DACH) (Lassen and Malmsten, 1997), 1,3-diaminopropane (Gengenbach et al, 1999), ethylenediamine (Gengenbach et al, 1996), butylamine (Gancarz et al, 2003), propargylamine and propylamine (Fally et al, 1995), acetonitrile (Hiratsuka et al, 2000) and acrylonitrile (Inagaki et al, 1992).

### Example 1

### Antibacterial Thin HA Plasma Polymer Films Embedded with Silver Nanoparticles

### Materials and Methods

### Materials

HA, silver nitrate, sodium borohydrate, and glass substrates were used as supplied by the manufacturer (Sigma-Aldrich, St. Louis, Mo., United States of America). Bacterial inhibition studies were conducted using Staphylococcus epidermidis strain ATCC 35984, prepared by overnight culture at 37° C. in tryptone soy broth (TSB) prepared according to the manufacturer's instructions with 0.25% glucose. Live and/or dead bacteria and/or colonies were observed following bacterial inhibition studies using a BacLight™ bacterial viability kit (Invitrogen Corporation, Canada) and visualised by fluorescence microscopy (Olympus BX 40, with exciter filter BP460-490, dichroic beam splitter DM505, barrier filter BA515-IF) at a magnification object of 40 times. All washing procedures were performed using ultrapure water (resistivity 18.2 Ohms).

### Plasma Polymerisation Method

Plasma polymerisation was performed in a custom built reactor described by Griesser, H J (1989), which is herein incorporated by reference. Briefly, the reactor chamber comprises a Pyrex cylinder and two PVC end plates. A circular groove in each end plate holds an o-ring seal that faces the polished end of the glass cylinder. The top lid carries the drive motor and gears and the bottom plate carries all the fittings located inside the reactor. The fittings comprise solid blocks machined from Teflon or Perspex. Two blocks located in the central plane hold the copper electrodes, which are of dimension 18 mm×90 mm and are spaced 16 mm apart. The gas inlet and outlet ports and the electrical feedthroughs are sealed by o-rings. For disassembly, the top end plate and the glass cylinder may be lifted off. The rf power is supplied via brass conductors embedded in the blocks and connect to the feedthroughs by a push-in fitting. Except for the reactor, the rf generator and the glass vacuum line are of standard design and, including a cold trap, were standard commercial items.

A 13.56 MHz plasma generator was utilised for deposition in all cases, which was carried out at pressure of 0.2 Torr. The time of deposition was adjusted by taking into account the deposition rate at certain power, known from previous studies to be 1 nm per second of plasma duration, in order to obtain a desired film thickness. Glass substrate were cleaned first by Piranha solution, copiously rinsed with water and dried. Before plasma deposition, substrates were cleaned by oxygen plasma for 40 seconds using power of 40 W.

### Silver Loading Method

Silver loading was carried out by immersion of the plasma polymer film into a solution of 0.02 M AgNO₃ for a standard loading time of 1 hr, or in loading time studies between 0 and 120 min.

### Silver Reduction Method

Silver reduction was carried out by immersion of the silver loaded plasma polymer film into a solution of 0.01M solution of NaBH₄ for a standard reduction time of 30 min, or in reduction time studies between 0 and 60 min.

### UV-Vis Spectroscopy

UV-visible spectra were observed and recorded using a Carry 5 UV-vis spectrometer (Varian Australia Pty Ltd, Melbourne, Australia).

### Bacterial Inhibition Studies

Prior to bacterial inhibition studies, bacterial stock cultures were quantified using the BacLight™ bacterial viability assay for the quantification of live bacteria. Test antibacterial slides were each placed within a well of a 12 micro well plate (disposable cell culture, Nunclon™ Surface, Denmark) and immobilised therein. Slides were inoculated with 10⁷ CFU/ml (approximately 200 μl) Staphylococcus epidermidis strain ATTCC 35984 from broth culture. Plates were incubated for 4 hrs at 37° C. to allow bacterial colonies to form. Slides were removed from the 12-well plate, and washed twice with 2 ml PBS (8 g/L NaCl, 0.2 g/L KCl, 1.44 g/L Na₂HPO₄ and 0.24 g of KH₂PO₄, adjusted to pH to 7.4 with HCl). 200 μl of a fixing reagents comprising 10% formaldehyde in saline solution (0.9% w/v NaCl solution) was dropped onto each slide and bacterial colonies were fixed to the slide surface for 10 minutes. The fixing reagent was removed and 200 μl of the BacLight™ staining reagent was dropped onto each slide in a dark room and shaken gently at approximately 10 strokes/ minute for 15 minutes. The stained slides were then rinsed with saline solution and prepared for visualisation by placing onto the glass slide surface, wetting the slide surface by mounting oil and covering with a cover glass. Slides were visualised by fluorescence microscopy (Olympus BX 40).

### Results and Discussion

Fabrication of HA Plasma Films Loaded with Silver Nanoparticles

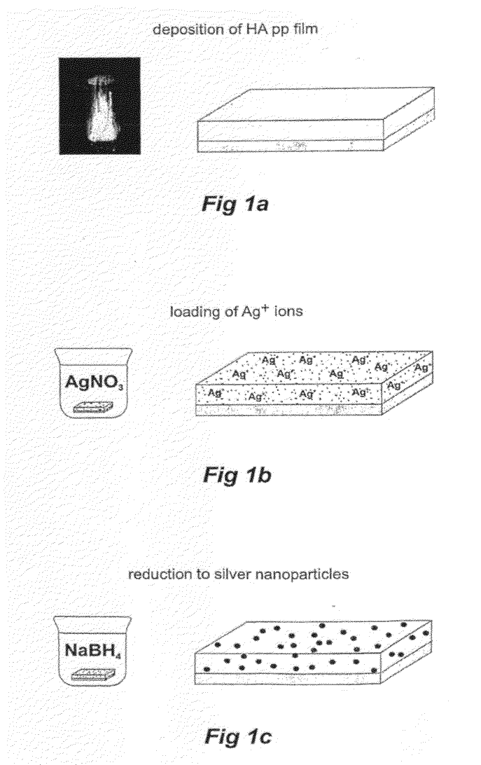

As illustrated in FIG. 1(a), HA was used as a precursor to generate a thin plasma polymer film rich in amine functional groups. HA was initially deposited on a clean glass surface using a custom built reactor (described above). Atomic force imaging of thin plasma polymer films showed suitably prepared films to comprise a nanoporous structure (Vasilev et al, 2008).

Silver ions were embedded into the film by soaking the films in a solution of AgNO₃ for 1 hr to complex silver ions (Ag⁺) in solution with HA amine groups as shown in FIG. 1(b). While not wishing to be bound by theory, it is believed that the complex is formed according to the following reaction:

Ag⁺+2RNH₂→[Ag(RNH₂)₂]⁺

As illustrated in FIG. 1(c), silver ions were reduced to silver nanoparticles by immersion of the thin plasma film in a solution of NaBH₄. This process produces a thin film polymer surface coating comprising silver nanoparticles embedded therein.

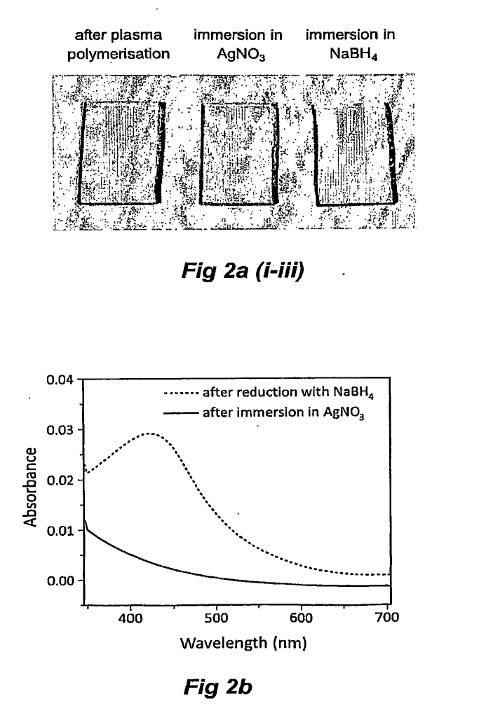

FIG. 2(a) illustrates the optical properties of the glass substrate during the deposition process. Following deposition of a 100 nm HA plasma film, the glass substrate is still transparent and maintains the initial optical properties. Again, following immersion in AgNO₃ (ie the loading of silver ions into the film), no visible change in the optical properties of the glass substrate was observed. However, following the reduction of silver ions to silver nanoparticles by immersion of the substrate in NaBH₄, the color of the glass substrate changed to yellow-brownish. The change in optical properties of the surface is indicative of the presence of silver nanoparticles embedded within the film.

FIG. 2(b) shows the absorbance spectrum of the glass substrate loaded with silver ions alone, in contrast with silver ions reduced to silver nanoparticles, across the absorbance spectrum from UV to wavelengths in the visible spectrum. The well-pronounced peak of absorbance at a wavelength of about 420 nm, appearing only after reduction, demonstrates the plasmon resonance wavelength of silver nanoparticles embedded within the film.

### Adjustment of Nanoparticle Loading Concentration

Several studies were conducted to determine the most effective way to control the concentration of silver nanoparticles embedded within films, demonstrating that antimicrobial plasma films providing various antimicrobial doses could be fabricated. Initially, a series of studies were conducted to understand the effect of altering plasma deposition conditions or antimicrobial loading conditions on the concentration of silver nanoparticles embedded within films. The intensity of plasmon resonance at wavelength of about 410-420 nm was measured in HA plasma films formed at a deposition power of 40 W following adjustment of;
(a) Ag⁺ loading time,
(b) reduction time, and
(c) film thickness.

### (a) Ag⁺ Loading Time

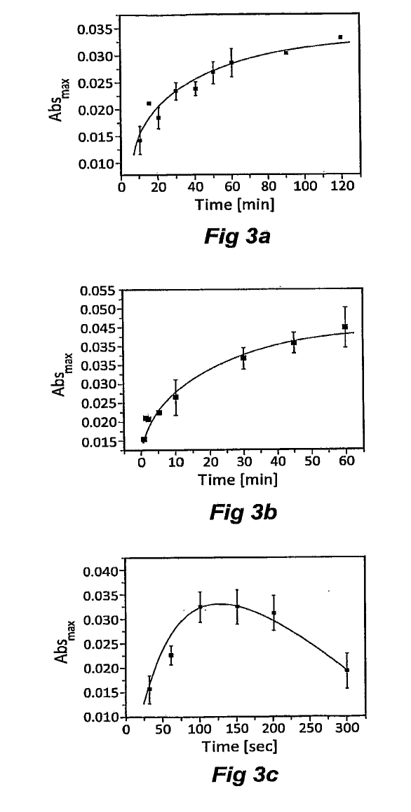

The effect of the time of immersion in AgNO₃ on the final concentration of silver nanoparticles within the HA plasma film was determined based on the intensity of the absorption maximum of the film. All conditions were maintained constant except for the length of immersion in AgNO₃ solution. As shown in FIG. 3(a), the absorption intensity continued to increase throughout the 120 min period of immersion in AgNO₃, with the greatest increase in absorption observed in the first 0-40 min. After 60 min of immersion, absorption continued to increase, however, at a much slower rate.

These results demonstrate that an increase in the time of immersion of the HA plasma film in AgNO₃ solution improves the availability of silver ions to the HA amine functional groups, which in turn, lead to an increase in the concentration of silver nanoparticles that are formed following the reduction of silver ions.

### (b) Reduction Time

The effect of reduction time on the final concentration of silver nanoparticles formed within the HA plasma polymer was assessed, as above, by an observed change in the absorption maximum of the film. Again, plasma polymerisation conditions were maintained constant with reduction time in NaBH₄ monitored at regular intervals for 60 min. As shown in FIG. 3(a), within the first 10 min, the formation of silver nanoparticles proceeded rapidly, with the total concentration of silver nanoparticles almost doubling after 30 min. From 30 min to 60 min, the rate of reduction slowed although an increase in nanoparticle formation continued to be observed.

In addition, a change in the wavelength of the absorption maximum was observed following immersion of films in NaBH₄ for longer periods (ie beyond 30 min) such that a slight shift to a longer wavelength of about 424 nm was observed. It is suspected that the shift in the plasmon resonance peak, found to be typical for longer reduction times, may be explained by the utilisation of the silver ions embedded within the HA plasma polymerised film for the continued growth of existing nanoparticles, whereas in the first 30 min, nucleation occurs and particles grow to a certain size which is common to all particles.

### (c) Film Thickness

The effect of film thickness on the concentration of silver nanoparticles embedded within HA polymer films was investigated by increasing the time of deposition, which in turn produced a thicker film. As shown in FIG. 3(c), an interdependence is observed whereby increasing film thickness up to 100 nm provides a steep increase in the total concentration of embedded silver nanoparticles. However, in films of a thickness of between about 100 nm and about 200 nm, the concentration of silver nanoparticles remained constant and thereafter, the concentration of silver nanoparticles gradually decreased.

These results indicate that increasing deposition time causes a gradual change in the chemical and surface properties of HA plasma films. It is suspected that increasing deposition time causes an increase in the cross-linking of functional groups, which consequently, reduces the number of functional groups available for forming silver ion complexes, and additionally reduces the number of pores available for loading with silver nanoparticles.

### Adjustment of Antimicrobial Release Rate

In addition to controlling the concentration of silver nanoparticles embedded within films, alterations in the retention characteristics of silver nanoparticles within films were studied to provide films with various antimicrobial release rates (ie from instant release rates to sustained release rates).

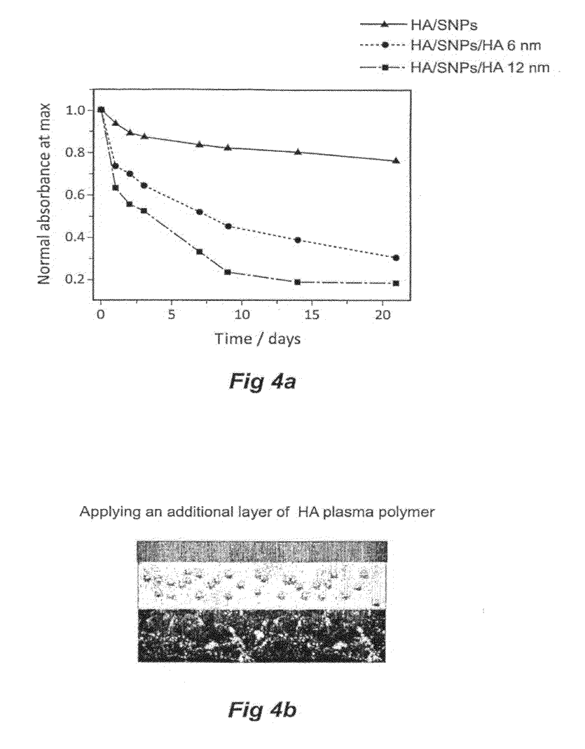

The release rate of silver from HA-silver plasma films in aqueous solution was monitored. As illustrated in FIG. 4(a) (indicated by squares), silver nanoparticles undergo oxidation in aqueous systems such that they dissolve and silver ions are eluted. The control of the rate of release of silver ions can provide films with a prolonged or sustained release of antimicrobial silver. Thus, to reduce the rate of release of silver from HA-silver plasma films, a second thin layer of HA was deposited on the surface of the HA-silver plasma films as illustrated in FIG. 4(b).

### (a) Control of Release Rate Using Multi-Layered Films

The release of silver was studied in HA-silver plasma films coated with an additional 6 nm or 12 nm HA plasma film by monitoring the elution of silver ions in PBS over a 21 day period. Elution of silver ions from the bi-layer films was observed by a change in the intensity of the plasmon resonance peak at 420 nm. FIG. 4(a) shows that the deposition of an additional 6 nm (indicated by circles) or 12 nm (indicated by triangles) HA plasma film, reduced the rate of release of silver ions, in contrast with films without an additional HA plasma film (indicated by squares).
Increasing the thickness of the additional plasma film to 12 nm (indicated by triangles) showed a further reduction in the rate of release of silver ions, over films comprising a 6 nm film (indicated by circles). Evidently, the release of silver ions from HA-silver plasma films can be effectively controlled by applying an additional surface plasma coating, whereby the rate of release of silver ions can be reduced by applying a surface coating of greater thickness.

### Antibacterial Properties of HA-Silver Plasma Films

To assess the antibacterial properties of HA-silver plasma films, HA plasma films, HA-silver plasma films and HA-silver plasma films coated with a 6 nm HA film, were subjected to the bacterial inhibition assays described above.

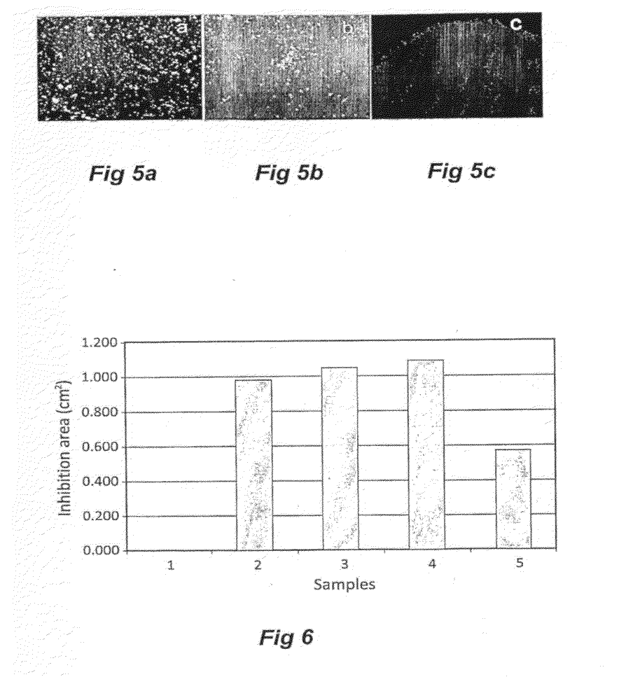

FIG. 5(a) shows that bacteria readily adsorb onto HA plasma films that do not contain silver nanoparticles, and start colonising the surface within 4 hrs. Whereas, when the same films are embedded with silver nanoparticles, fewer bacteria are able to adsorb on the surface and very little bacterial colonisation is observed. Moreover, the appearance of reddish colonies was observed in HA-silver plasma films, which is indicative of bacterial death (red/green staining following BacLight™ staining). FIG. 5(c) illustrates bacterial attachment and growth in the sustained release films formed by applying an additional HA plasma film on the surface of HA-silver plasma films. Following an extended 6 hour incubation period, only a few single bacteria are observed to be attached to the surface, showing a 10⁷ CFU/ml die off. In addition, no sign of bacterial colonisation was observed.

The HA-silver plasma films clearly exhibit at least a bacteriostatic activity over films that do not contain silver nanoparticles, and are likely to exhibit bacteriocidal properties. While some bacteria can be observed on HA-silver plasma films, sustained release films coated with an additional HA plasma film exhibit prolong bacteriocidal properties and dramatically reduce the number of bacteria applied to the surface of the coating.

The methods described thereby provide an efficient procedure for the fabrication of antibacterial coatings by rfgd plasma polymerisation that can be deposited on practically any type of solid surface. Further, the concentration of silver nanoparticles loaded into plasma films and the released rate of antimicrobial silver ions can be controlled by modifying deposition time, duration of silver loading, reduction time or by deposition of an additional surface coating with an HA plasma film.

### Example 2

### Fabrication of Thin Plasma Polymer Films Embedded with Copper Nanoparticles

### Materials and Methods

The methods for fabricating HA-silver plasma films described above may be readily adapted for forming HA plasma films comprising other metal nanoparticles. Cu³⁰ and Se are also known antimicrobial agents, and accordingly, copper and/or selenium nanoparticles may be used instead of silver nanoparticles in the HA plasma films.

The methods described above will be replicated with appropriate modifications made to the “silver loading method” to load Cu⁺ into HA plasma films rather than Ag⁺. In particular, 0.02 M AgNO₃ in the “silver loading method” will be replaced with 0.02 M CuNO₃. It is envisaged that the concentration of CuNO₃ and copper loading time may require optimisation, although little change to the deposition or reduction steps is expected to be necessary.

The rate of Cu⁺ loading and release will be assessed and optimised and the antimicrobial activity of HA-copper plasma films will be determined as described above.

### Example 3

### Effectiveness of Antibacterial Thin Plasma Polymer Films with Silver Nanoparticles Against Gram Negative Bacteria

In Example 1, the antibacterial thin plasma polymer films with embedded silver nanoparticles were found to be effective in inhibiting a representative gram positive bacteria, namely Staphylococcus epidermidis strain ATTCC 35984. In this example, a study was conducted to assess the effectiveness of such films against gram negative bacteria, which are often more difficult to inhibit.

### Materials and Methods

### Bacterial Inhibition Study

Prior to the bacterial inhibition study, a stock culture of Escherichia coli K12 (MG1655) strain was quantified using the BacLight™ bacterial viability assay for the quantification of live bacteria. Square samples (1 cm²) of HA plasma film loaded with silver nanoparticles on glass substrate, prepared as described above in Example 1 (with and without a HA overlayer film), were placed film-side down on Petri dishes filled with solid LB medium (rich medium) along with a round glass coverslip as a control. Thereafter, 100 μl of the stock culture was inoculated onto the solid medium. The samples tested were as follows:
Sample 1 HA plasma film only
Sample 2 HA-silver plasma film
Sample 3 Bilayer film comprising HA-silver plasma layer with 6 nm HA overlayer
Sample 4 Bilayer film comprising HA-silver plasma layer with 12 nm HA overlayer
Sample 5 Bilayer film comprising HA-silver plasma layer with 18 nm HA overlayer

### Results and Discussion

The Petri dishes including samples with a HA-silver plasma film showed a clear area of bacterial inhibition around the square samples of silver loaded film. Utilising optical microscopy, the area of inhibition was estimated. The results are shown in FIG. 6. Clearly, all samples loaded with silver efficiently inhibited bacteria growth. For the bilayer samples, an HA plasma overlayer thickness of above 12 nm (used to slow down the rate of release of silver), the inhibition area was reduced by about 50%.

### Example 4

### Antibacterial Thin Allylamine Plasma Polymer Films Embedded with Silver Nanoparticles

### Materials and Methods

### Materials

Allylamine (AA), silver nitrate, sodium borohydrate, and glass substrates were used as supplied by the manufacturer (Sigma-Aldrich, St. Louis, Mo., United States of America). Bacterial inhibition studies were conducted using Staphylococcus epidermidis strain ATCC 35984, prepared by overnight culture at 37° C. in tryptone soy broth (TSB) prepared according to the manufacturer's instructions with 0.25% glucose. Live and/or dead bacteria and/or colonies were observed by fluorescence microscopy. All washing procedures were performed using ultrapure water (resistivity 18.2 Ohms).

### Plasma Polymerisation Method

Plasma polymerisation was performed in a custom built reactor (Griesser, H J, 1989) as briefly described in Example 1. A 13.56 MHz plasma generator was utilised for deposition, which was carried out at pressure of 0.2 Torr. The time of deposition was adjusted by taking into account the deposition rate at certain power, known from previous studies to be 1 nm per second of plasma duration, in order to obtain the desired film thickness (eg 18 nm). Glass substrate were cleaned first by Piranha solution, copiously rinsed with water and dried. Before plasma deposition, substrates were cleaned by oxygen plasma for 40 seconds using power of 40 W. In some cases, an AA overlayer was applied, following silver loading and reduction, to produce a bilayer film. The overlayer was applied to a thickness of 6 nm, 12 nm or 18 nm.

### Silver Loading Method

Silver loading was carried out by immersion of the plasma polymer film into a solution of 0.02 M AgNO₃ for a standard loading time of 1 hr.

### Silver Reduction Method

Silver reduction was carried out by immersion of the silver loaded plasma polymer film into a solution of 0.01M solution of NaBH₄ for a standard reduction time of 30 min.

### UV-Vis Spectroscopy

UV-visible spectra were observed and recorded using a Carry 5 UV-vis spectrometer (Varian Australia Pty Ltd, Melbourne, Australia).

### Bacterial Inhibition Studies

Prior to bacterial inhibition studies, a stock culture of S. epidermidis strain ATTCC 35984 was quantified using the BacLight™ bacterial viability assay for the quantification of live bacteria. Test antibacterial slides were each placed within a well of a 12 micro well plate (disposable cell culture, Nunclon™ Surface, Denmark) and immobilised therein. Slides were inoculated with 10⁷ CFU/ml (approximately 200 μl) of the S. epidermidis strain from the stock culture. Plates were incubated for 4 hrs at 37° C. to allow bacterial colonies to form. Slides were removed from the 12-well plate, and prepared as described in Example 1 for visualisation of bacteria by fluorescence microscopy.

### Results and Discussion

Fabrication of AA Plasma Films Loaded with Silver Nanoparticles

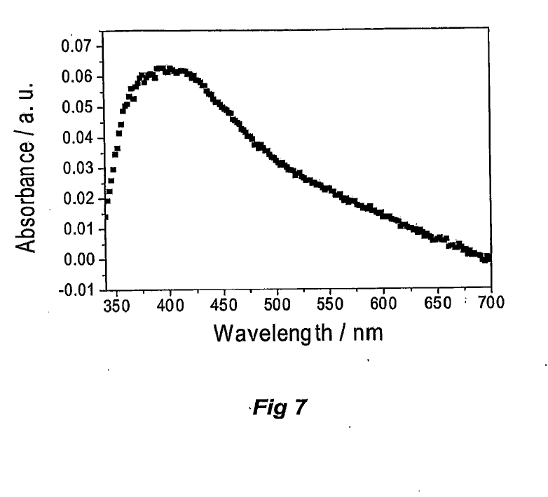

AA was used as a precursor to generate a thin plasma polymer film rich in amine functional groups on a clean glass surface using a custom built reactor. Silver ions were embedded into the film by soaking the films in a solution of AgNO₃ for 1 hr to complex silver ions (Ag⁺) in solution with AA amine groups. Thereafter, the silver ions were reduced to silver nanoparticles by immersion of the thin plasma film in a solution of NaBH₄. FIG. 7 shows the absorbance spectrum (325 to 700 nm) of the film loaded with silver nanoparticles; the absorbance peak at about 420 nm demonstrates the plasmon resonance wavelength of silver nanoparticles embedded within the film.

### Control of Release Rate Using Multi-Layered Films

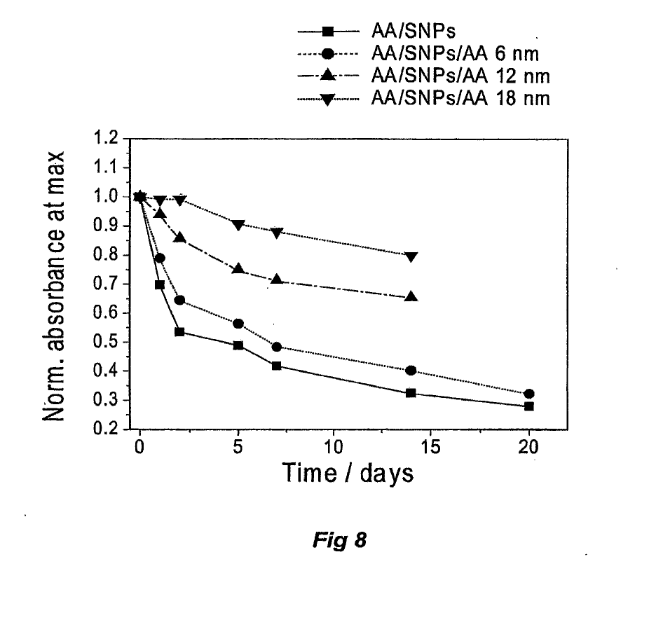

The release rate of silver from the AA-silver plasma films in aqueous solution was monitored. To reduce the rate of release of silver, a second thin layer of AA (6, 12 or 18 nm) was deposited on the surface of the AA-silver plasma films. The elution of silver ions in PBS was monitored over a 21 day period by a change in the intensity of the plasmon resonance peak at 420 nm. FIG. 8 shows that the deposition of an additional 6 nm (indicated by circles) or 12 nm (indicated by upwards-pointing triangles) AA plasma film, reduced the rate of release of silver ions, in contrast with films without an additional AA plasma film (indicated by squares). Further, increasing the thickness of the additional plasma film to 18 nm (indicated by downwards-pointing triangles) showed a further reduction in the rate of release of silver ions, over films comprising a 12 nm film (indicated by upwards-pointing triangles).

### Antibacterial Properties of HA-Silver Plasma Films

To assess the antibacterial properties of AA-silver plasma films, AA plasma films, AA-silver plasma films and AA-silver plasma films coated with a 6 nm AA film, were subjected to the bacterial inhibition assays described above.

The results observed with AA plasma films were similar to those described above in Example 1 for HA films. That is, it was found that bacteria readily adsorb onto the AA plasma films that do not contain silver nanoparticles, and start colonising the surface within several hours. In contrast, when the same films included embedded silver nanoparticles, less bacteria are able to adsorb on to the surface and little colonisation was seen. Further, where an additional AA plasma overlayer film was included on the surface of AA-silver plasma film, only a few single bacteria were found to be attached to the surface (following an extended 6 hour incubation period) and no sign of colonisation.

### Example 5

### Immobilisation of Ligands onto Antibacterial Thin HA Plasma Polymer Films Embedded with Silver Nanoparticles

The antibacterial films of the present invention are provided with one or more chemically reactive functional groups which enable the opportunity to provide additional functional characteristics and/or modify the properties of the surface. To demonstrate this, in this example, polyethylene glycol (PEG) was immobilised onto the amine-group bearing surface of a HA-silver plasma film prepared in accordance with the method described in Example 1 via reductive amination. This reaction only occurs because of the presence of surface amine groups available to react covalently with the aldehyde end groups of PEG-aldehyde.

### Materials and Methods

PEG “grafting” to the surface of the HA-silver plasma film was carried out at 60° C. for 12 hours in PBS. XPS analysis and survey spectrum analysis of the product were conducted according to standard procedures.

### Results and Discussion

XPS spectrum analysis of HA-silver plasma polymer films was conducted before and after immobilisation of PEG (“PEG grafting”). Four elements were clearly identifiable from the XPS spectrum of the coating before PEG grafting, namely carbon, nitrogen and oxygen (from the plasma polymer film) and silver (from the silver nanoparticles). A high resolution XPS spectrum of the C1s peak showed that the predominant form of carbon of the surface is aliphatic (C—C, C—H bonds). In contrast, in the surface chemical composition after PEG grafting, a prominent peak appeared in the XPS spectrum of the C1s region due to the C—O contribution of the grafted PEG.

Changes in the survey spectrum also occurred. Silver and nitrogen peaks decreased in intensity because of the PEG overlayer. The oxygen amount also increased due to the C—O content in the PEG.

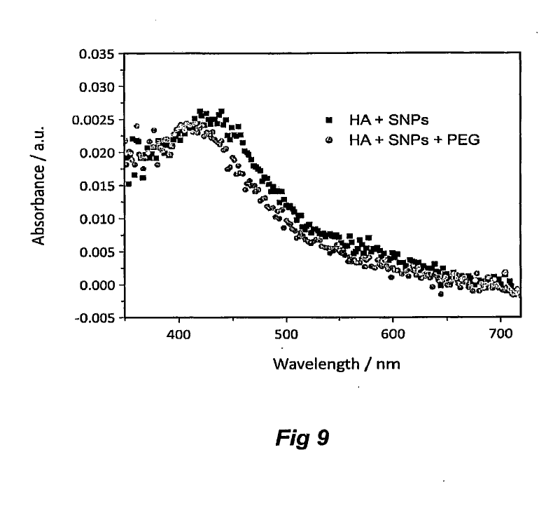

Further, to show that the silver nanoparticles remain in the coating after PEG grafting, UV-vis spectroscopy was conducted (see FIG. 9). This showed that despite the reaction involved in the PEG grafting, which could have conceivably led to oxidation of the silver nanoparticles, the Plasmon resonance absorption due to the presence of silver nanoparticles was still present after PEG grafting. However, the slight shift to a shorter wavelength, and the small drop in intensity, show that oxidation processes have occurred but to a limited extent.

The results of this example demonstrate that sufficient numbers of amine functional groups are still available on the surface of the polymer matrix after silver nanoparticles loading into HA plasma polymer films, and can be utilised for immobilisation of various ligands such as chemical compounds and biological molecules (proteins, peptides etc).

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

Alt, V et al., Biomaterials 25:4383 (2004).
Caruso, D M et al., J Burn Care Rehabil 25:89 (2004).
Chou, W L et al., Polym Adv Technol 16:600 (2005).
Dubas, S T et al., Colloid Surf A-Physicochem Eng Asp 289:105 (2006).
Fally, F et al., J Appl Polym Sci 56:597-614 (1995).
Gancarz, I et al., Eur Polymer J39:2217-2224 (2003).
Gengenbach, T R et al., Surface Interface Anal 24:611-619 (1996).
Gengenbach, T R and H J Griesser, J Polymer Sci Part a-Polymer Chemistry 37:2191-2206 (1999).
Gosheger, G et al., Biomaterials 25:5547 (2004).
Griesser, H J, Vacuum 39(5):485-488 (1989).
Hardman, S et al., Ann Vasc Surg 18:308 (2004).
Hiratsuka, A et al., J Memb Sci 175:25-34 (2000).
Inagaki, N et al., J Poly Sci Part a-Polymer Chemistry 30:2003-2010 (1992).
Lassen, B and M Malmsten, J Colloid Interface Sci 186:9-16 (1997).
Lee, H J et al., J Mater Sci 38:2199 (2003).
Losic, D et al., Nanotechnology 19:245704 (2008).
Li, Z et al., Langmuir 22:9820 (2006).
Martin, TP et al., Biomaterials 28:909 (2007).
Martinez, S S et al., J Hydrog Energy 29:921 (2004).
Mahltig, B et al., J Sol-Gel Sci. Technol 32:219 (2004).
Marini, M et al. Biomacromolecules 8:1246 (2007).
O'Donnell, M J et al., J Dent 35:438 (2007).
Ohashi, S et al., J Oral Rehabil 31:364 (2004).
Paddock, H N et al., J Burn Care Res 28:409 (2007).
Rupp, M E et al., Am J Infect Control 32:445 (2004).
Song, J S et al., J Appl Polym Sci 96:1095 (2005).
Tobin, E J et al., Ther Apher Dial 7:504 (2003).
Vasilev, K et al., Chem Comm 3600-3602 (2009).
Voccia, S et al., Langmuir 22:8607 (2006).

1. A film comprising a permeable polymer matrix provided with one or more functional groups and, embedded within said polymer matrix, one or more nanoparticles of an inorganic substance.

2. The film of claim 1, wherein the polymer matrix is a porous polymer matrix.

3. The film of claim 1, wherein the polymer matrix is a plasma polymer matrix.

4. The film of claim 3, wherein the polymer matrix is between about 5 nm and about 150 nm in thickness.

5. The film of claim 3, wherein the polymer matrix is between about 5 nm and about 25 nm in thickness.

6. The film of claim 1, wherein the inorganic substance is a non-carbon element in a substantially pure form.

7. The film of claim 6, wherein the non-carbon element is copper, silver, selenium or a combination thereof.

8. The film of claim 3, wherein the polymer matrix is formed from alkylamine monomer.

9. The film of claim 8, wherein the alkylamine monomer comprises n-heptylamine, allylamine or a combination thereof.

10. The film of claim 1, wherein the film is a multi-layered film comprising first and second polymer film layers, said first film layer comprising a polymer matrix provided with one or more functional groups and, embedded within said polymer matrix, one or more nanoparticles of an inorganic substance, and wherein said second film layer provides the film with additional functional characteristics and/or modify the properties of the first film layer.

11. The film of claim 10, wherein the second film layer modifies permeation of the inorganic substance from the first film layer to provide a multi-layered film which releases said inorganic substance in a sustained manner.

12. The film of claim 10, wherein the film comprises at least a third film layer which comprises a useful ligand.

13. The film of claim 10, wherein the second film layer is from about 5 to about 25 nm in thickness.

14. The film of claim 1, wherein the film is provided as a coating on the surface of a suitable substrate.

15. A method for applying a film onto a surface of a suitable substrate, said method comprising the steps of:
depositing and polymerising a monomer comprising one or more functional groups by plasma polymerisation to form a permeable polymer matrix on said surface;
(ii) complexing an inorganic substance to said functional groups, and
(iii) reducing said inorganic substance to form one or more nanoparticles of said inorganic substance;
wherein said one or more nanoparticles of said inorganic substance is embedded within said polymer matrix.

16. The method of claim 15, wherein the polymer matrix is a porous polymer matrix.

17. The method of claim 16, wherein the step of depositing and polymerising the monomer is performed by radio frequency glow discharge (rfgd) plasma polymerisation.

18. The method of claim 17, wherein the monomer comprises n-heptylamine, allylamine or a combination thereof.

19. The method of claim 15, wherein the film produced by steps (i) to (iii) constitutes a first film layer comprising a first polymer matrix provided with one or more groups and, embedded within said first polymer matrix, one or more nanoparticles of an inorganic substance and the method further comprises the step of:
(iv) applying a second film layer to a surface of the first film layer, to thereby produce a multi-layered film.

20. The method of claim 19, wherein the method further comprises the step of:
(v) applying a third film layer to a surface of the second film layer.
